(19) United States
(12) Patent Application Publication
(10) Pub. No.: US 2010/0164642 A1
(43) Pub. Date: Jul. 1, 2010

(54) NON-RECIPROCAL CIRCUIT DEVICE

(75) Inventor: Shingo OKAJIMA, Yasu-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: Murata Manufacturing Co., Ltd., Nagaokakyo-shi (JP)

(21) Appl. No.: 12/634,750

(22) Filed: Dec. 10, 2009

(30) Foreign Application Priority Data
Dec. 26, 2008 (JP) 2008-334246

(51) Int. Cl. H01P 1/32; H01P 1/36

(52) U.S. Cl. 333/24.2; 333/1.1

(57) ABSTRACT

A non-reciprocal circuit device includes a ferrite arranged to receive a direct-current magnetic field from a permanent magnet, a first central electrode and a second central electrode arranged on main surfaces of the ferrite. Electrodes are provided in recesses provided on both top and bottom surfaces of the ferrite. These electrodes are soldered to terminal electrodes provided on a circuit board and include a countermeasure to prevent the electrodes from detaching from the recesses when a pulling force is applied to a joining portion therebetween.

### BACKGROUND OF THE INVENTION

1. Field of the Invention

The present invention relates to a non-reciprocal circuit device and, in particular, to a non-reciprocal circuit device, such as an isolator or a circulator, used in microwave bands.

2. Description of the Related Art

A non-reciprocal circuit device, such as an isolator or a circulator, has known characteristics that allow transmission of a signal in a predetermined direction and not in a reverse direction. Because of these characteristics, for example, an isolator is commonly used in a transmitter circuit of a mobile communication device, such as an automobile telephone or a cellular phone, for example.

International Publication No. 2007/046229 discloses a 2-port isolator in which a first central electrode and a second central electrode are arranged respectively on a first main surface and an opposed second main surface of a ferrite, and the first and second central electrodes on the first main surface side and the second main surface side are connected with electrode conductors embedded in recesses which are provided on edge surfaces of the ferrite.

In the 2-port isolator, the electrode conductors in the recesses, which are provided on edge surfaces of the ferrite, are connected to terminal electrodes, which are provided on a circuit board, by a conductive material as a solder, for example. However, an anchoring strength of the electrode conductors in the recesses is not always sufficient. When a large pulling force or pushing force is applied to the ferrite, problems such as breakage of the electrical connections caused by detachment of the electrode conductors, tend to occur. The problems were especially obvious when the conductors were formed in the recesses by a plating method.

### SUMMARY OF THE INVENTION

To overcome the problems described above, preferred embodiments of the present invention provide a non-reciprocal circuit device in which the anchoring strength of the electrode conductors in the recesses of the ferrite is greatly increased.

A non-reciprocal circuit device according to a first preferred embodiment of the present invention includes a permanent magnet, a ferrite arranged to receive a direct-current magnetic field from the permanent magnet, a plurality of central electrodes defined by a conductive film and arranged on the ferrite so as to cross each other and so as to be electrically insulated from each other, electrode conductors arranged in recesses which are provided on edge surfaces which are perpendicular or substantially perpendicular to main surfaces of the ferrite, wherein the electrode conductors are electrically connected to the central electrodes and to terminal electrodes provided on a circuit board, the terminal electrodes being defined by a conductive material, and the electrode conductors include a countermeasure structure arranged to prevent detachment of the electrode conductors from the recesses when a pulling force is applied to portions of the electrode conductors joined to the terminal electrodes.

According to a preferred embodiment of the present invention, since a countermeasure structure that resists a pulling force applied to joining portions with the terminal electrodes on a circuit board is provided to prevent detachment of the electrode conductors from the recesses, the anchoring strength to the recesses is increased. Accordingly, even if an excessive pulling force or pushing force is applied to the ferrite, detachment of the electrode conductors is prevented and breakage of the circuit connection is prevented.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view illustrating a 2-port type isolator according to a first preferred embodiment of the present invention.

FIG. 2A is a perspective view illustrating a ferrite with electrodes and FIG. 2B is a perspective view illustrating the ferrite without electrodes.

FIG. 3 is an exploded perspective view illustrating a ferrite-magnet assembly.

FIG. 4 is an equivalent circuit diagram illustrating a circuit example of the 2-port type isolator.

FIGS. 5A to 5G are elevation views illustrating various shapes of electrodes.

FIG. 6 is a perspective view illustrating a main portion of 2-port type isolator according to a second preferred embodiment of the present invention.

FIG. 7 is a perspective view illustrating a main portion of 2-port type isolator according to a third preferred embodiment of the present invention.

### DETAILED DESCRIPTION OF THE PREFERRED EMBODIMENTS

Non-reciprocal circuit devices according to preferred embodiments of the present invention will now be described below with reference to the accompanying drawings.

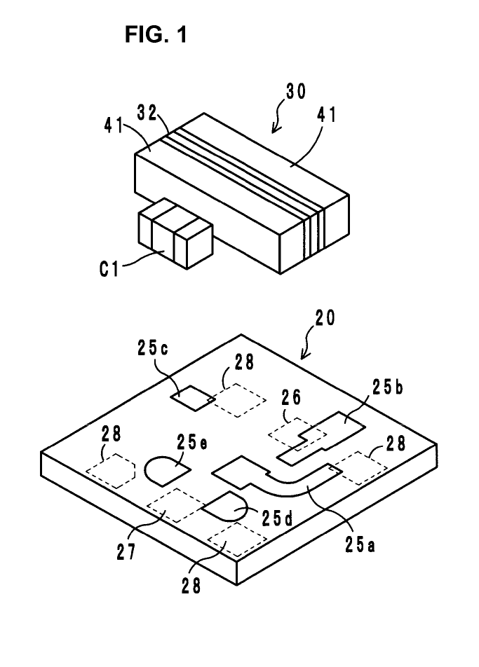

FIG. 1 shows an exploded perspective view of a 2-port type isolator of a non-reciprocal circuit device according to a first preferred embodiment of the present invention. The 2-port type isolator is preferably a lumped constant type isolator, which preferably includes a circuit board 20, a ferrite-magnet assembly 30 which includes a ferrite 32 and a pair of permanent magnets 41 and matching circuit elements. Capacitor C1 is preferably mounted on the circuit board 20 and other elements are preferably embedded in the circuit board 20.

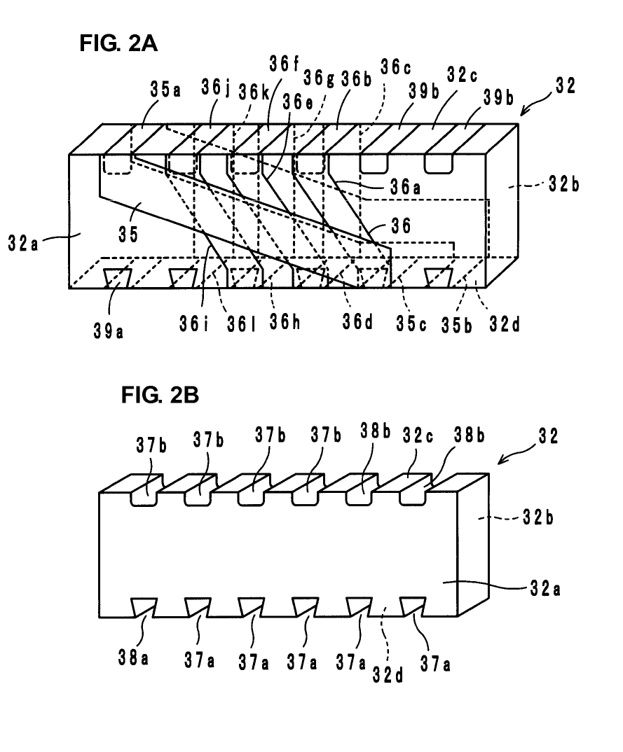

As shown in FIGS. 2A and 2B, a first central electrode 35 and a second central electrode 36, which are electrically insulated from each other, are located on front and back main surfaces 32a and 32b of the ferrite 32. The ferrite 32 preferably has a substantially rectangular parallelepiped shape having a first main surface 32a and a second main surface 32b arranged parallel or substantially parallel to each other, for example.

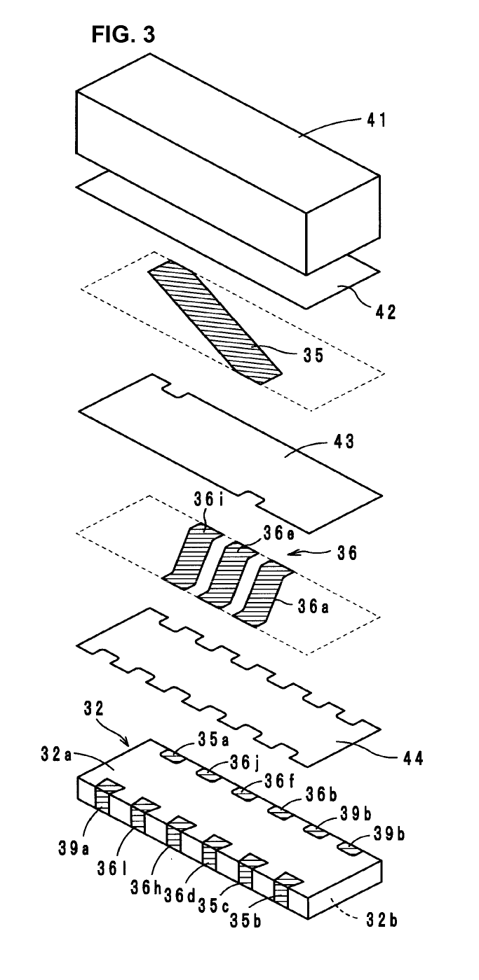

The permanent magnets 41 are bonded to the main surfaces 32a and 32b, with an epoxy based adhesive layer 42 interposed therebetween, for example, (see FIG. 3) so that a direct-current magnetic field is applied to be substantially perpendicular to the main surfaces 32a and 32b. Thus, the ferrite-magnet assembly 30 is provided. The main surfaces of the permanent magnets 41 preferably have the same or substantially the same dimensions as the main surfaces 32a and 32b, and are mounted with the main surfaces 32a and 41a, and the main surfaces 32b and 41a facing each other so that the peripheries of the main surfaces are aligned or substantially aligned.

The first central electrode 35 preferably includes a conductive film. That is, as shown in FIG. 2A, the first central electrode 35 extends on the first main surface 32a of the ferrite 32, rising from the lower right portion of the first main surface 32a, inclined at a relatively small angle with respect to the long side of the first main surface 32a, to the upper left portion of the ferrite 32 and extends to the second main surface 32b via a relay electrode 35a on the top surface 32c, then extends on the second main surface 32b such that the extended portion of the first central electrode 35 on the first main surface 32a and the extended portion thereof on the second main surface 32b oppose each other with the ferrite 32 disposed therebetween. One end of the first central electrode 35 is connected to a connection electrode 35b located on the bottom surface 32d. The other end of the first central electrode 35 is connected to a connection electrode 35c located on the bottom surface 32d. In this manner, the first central electrode 35 is wound around the ferrite 32 by one turn. The first central electrode 35 crosses the second central electrode 36 (described below) in an electrically insulated manner with an insulator layer 43 (see FIG. 3) interposed therebetween. A crossing angle between the central electrodes 35 and 36 is set as required in order to adjust the input impedance and the insertion loss.

The second central electrode 36 preferably includes a conductive film, for example. For the second central electrode 36, a 0.5-turn second central electrode 36a is provided, which extends from the lower side to the upper side of the first main surface 32a at a relatively large angle with respect to the long side of the first main surface 32a such that the second central electrode 36a crosses the first central electrode 35. The second central electrode 36a extends via a relay electrode 36b on the top surface 32c to the second main surface 32b, and then a 1-turn second central electrode 36c extends substantially vertically, crossing the first central electrode 35. The lower portion of the 1-turn second central electrode 36c extends to the first main surface 32a via a relay electrode 36d on the bottom surface 32d. A 1.5-turn second central electrode 36e extends in parallel or substantially in parallel with the 0.5-turn second central electrode 36a on the first main surface 32a such that the 1.5-turn second central electrode 36e crosses the first central electrode 35. The 1.5-turn second central electrode 36e then extends to the second main surface 32b via a relay electrode 36f on the top surface 32c. Similarly, a 2-turn second central electrode 36g, a relay electrode 36h, a 2.5-turn second central electrode 36i, a relay electrode 36j, a 3-turn second central electrode 36k, and a relay electrode 36l are successively provided on the surfaces of the ferrite 32. Both ends of the second central electrode 36 are respectively connected to the connection electrode 35c and 36l located on the bottom surface 32d of the ferrite 32. It is noted that the first central electrode 35 and the second central electrode 36 respectively share the connection electrode 35c as the terminal connection electrodes thereof.

The connection electrodes 35b, 35c, and 36l and the relay electrodes 35a, 36b, 36d, 36f, 36h, and 36j are preferably formed by filling the recesses 37a and 37b (see FIG. 2B) provided on the top and bottom surfaces 32c and 32d of the ferrite 32 with conductive material, such as silver, silver-based alloy, copper or copper-based alloy by plating, for example. Dummy recesses 38a and 38b are also provided on the top and bottom surfaces 32c and 32d in parallel or substantially in parallel with the recesses 37a and 37b, and then dummy electrodes 39a and 39b are provided in the recesses 38a and 38b. These types of electrodes are preferably formed as described below. Through-holes are formed in a mother ferrite board, and then filled with the conductive material. The mother ferrite board is then cut along a line that divides the through-holes.

The recesses 37a, 37b, 38a and 38b are preferably formed by making through-holes in the mother ferrite board by a blasting or a laser processing, for example. In the blast processing, a small particle size powder is preferably blasted onto a surface of a mother board through masking holes and the through-holes are formed. In the laser processing, a laser beam is irradiated to a surface of the mother board of the ferrite 32 and the through-holes are formed at predetermined locations.

As shown in FIG. 3, each member is laminated on a main surface 32a of the ferrite 32. The second central electrode 36 is provided on the main surface 32a with an adhesive layer 44 interposed therebetween, then the first central electrode 35 in provided on the on the second central electrode 36 with an insulator layer 43 interposed therebetween, and then the permanent magnet 41 is provided on the first central electrode 35 via an adhesive layer 42. Although it is not shown in FIG. 3, each member is laminated on the other main surface 32b of the ferrite 32.

YIG ferrite is preferably used for the ferrite 32, for example. The first and second central electrodes 35 and 36 and the other electrodes are preferably produced as a thick film or a thin film of silver or a silver-based alloy using printing, transfer printing, or photolithographic printing technique, for example. The insulator layer 43 between the central electrodes 35 and 36 may preferably be a dielectric thick film made of glass or alumina, or a resin film made of polyimide, for example. The insulator layer may also be produced using printing, transfer printing, or photolithographic printing technique, for example.

The ferrite 32 composed of a magnetic material can be produced by co-firing with the insulator layers and the various electrodes, for example. In such a case, an electrode material, such as Pd, or Pd/Ag, for example, which can withstand with a high firing temperature is preferably used.

The permanent magnet 41 is preferably a strontium-based ferrite magnet, a barium-based ferrite magnet, or a lanthanum-cobalt based ferrite magnet, for example. As an adhesive layer 42 for bonding the permanent magnet 41 and the ferrite 32, a thermo-setting one-component epoxy resin, for example, is preferably used.

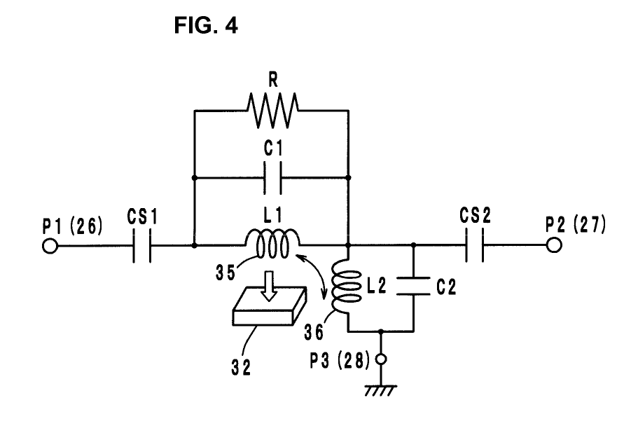

The circuit board 20 preferably includes a LTCC (Low temperature co-fired ceramics) ceramic substrate on which terminal electrodes 25a, 25b, 25c, 25d and 25e arranged to mount the ferrite-magnet assembly 30 described above and a chip type capacitor C1 which is a matching circuit element are provided on the top surface and an input electrode 26, an output electrode 27, and a ground electrode 28 are provided on the bottom surface. Referring to FIG. 4, matching circuit elements, capacitors C2, CS1, CS2 and a terminating resistor R, which are described below are defined by embedded internal electrodes in the circuit board 20, and a predetermined circuit is configured with via-hole conductors, for example.

The ferrite-magnet assembly 30 is disposed on the circuit board 20 such that the main surfaces 32a and 32b of the ferrite 32 are perpendicular or substantially perpendicular to the surface of the circuit board 20, and the connection electrodes 35b, 35c and 36l which are arranged at the bottom surface 32d of the ferrite 32 are preferably soldered to terminal electrodes 25a 25b and 25c which are provided on the surface of the circuit board 20 through a reflow soldering operation, for example. The ferrite-magnet assembly 30 and circuit board 20 define a unitary body. The capacitor C1 is preferably soldered to terminal electrodes 25d and 25e which are provided on the surface of the circuit board 20 preferably by a reflow soldering operation, for example.

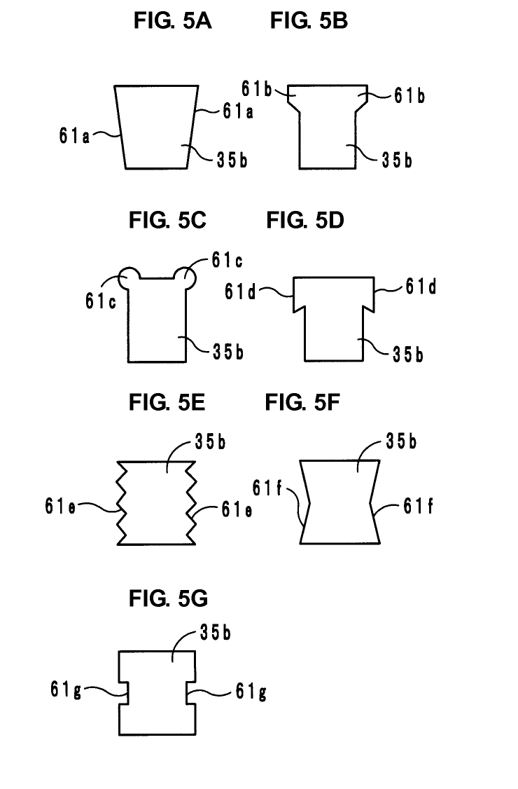

As shown in FIG. 2B, the recesses 37a and 38a which are provided on the bottom surface 32d of the ferrite 32 and which are filled with the electrodes 35b, 35c, 36d, 36h, 36l and 39a preferably have an inverted trapezoidal shape which is narrow at a lower side and wider at an upper side, and each of the electrodes 35b, 35c, 36d, 36h, 36l and 39a are filled into the recesses to 37a and 38a preferably to have the inverted trapezoidal shape. Accordingly, the anchoring strength of the electrode conductors is significantly increased, and even if a downward pulling force or horizontal pushing force is applied detachment of the electrode conductors from the recesses does not happen. Since the electrodes 35b, 35c and 36l are connected by soldering to terminal electrodes 25a, 25b and 25c respectively, a pulling force is applied to the electrodes 35b, 35c and 36l from the joining portion. According to the first preferred embodiment of the present invention, a countermeasure structure (for example, an inclined side surface 61a in FIG. 5A) is provided such that the electrodes 35b, 35c and 36l do not detach from the recesses 37a by the pulling force.

An equivalent circuit of an example of the 2-port isolator is shown in FIG. 4. An input electrode 26 provided on the bottom surface of the circuit board 20 functions as the input port P1 and is connected to the matching capacitor C1 and the terminating resistor R via the matching capacitor CS1. The matching capacitor CS1 is connected to a first end of the first central electrode 35 via the terminal electrode 25a which is provided on the top surface of the circuit board 20 and connection electrode 35b which is provided on the bottom surface 32d of the ferrite 32.

A second end of the first central electrodes 35 (L1) and a first end of the second central electrodes 36 (L2) are connected to the terminating resistor R and the capacitors C1 and C2 via the connection electrode 35c which is provided on the bottom surface 32d of the ferrite 32 and the terminal electrode 25b which is provided on the top surface of the circuit board 20. The second end of the first central electrodes 35 (L1) and the first end of the second central electrodes 36 (L2) are also connected to an output electrode 27 which is provided on the bottom surface of the circuit board 20 via the matching capacitor CS2. This terminal electrode 27 functions as the output port P2.

A second end of the second central electrode 36 is connected to the capacitor C2 via the connection electrode 36l which is provided on the bottom surface of 32d of the ferrite 32 and the terminal electrode 25c which is provided on the top surface of the circuit board 20, and is connected to a ground electrode 28 which is provided on the bottom surface of the circuit board 20. This terminal electrode 28 functions as the ground port P3.

In the 2-port type isolator having the above described configuration, since one end of the first central electrode 35 is connected to the input port P1 and the other end is connected to the output port P2, and one end of the second central electrode 36 is connected to the output port P2 and the other end is connected to the ground port P3, a 2-port type lumped constant isolator having low insertion loss is obtained. Furthermore, in the operation mode, a large high frequency current flows through the second central electrode 36, while virtually no high-frequency current flows through the first central electrode 35.

The circuit board 20 preferably includes a dielectric multilayered substrate. Since a circuit network including capacitors and resistors, for example, can be embedded in the circuit board 20, an isolator having a compact size and low profile is obtained. Since connections between circuit elements can be disposed inside of the substrate, the reliability is improved. The circuit board 20 is not limited to a multilayered substrate. A single layer on which the matching capacitors and other circuit element are mounted may be used. In addition, the circuit board 20 may be a print circuit board which is used for cellular phones, for example. In such a case, the ferrite-magnet assembly 30 defines one module and chip type matching circuit elements are mounted on the outside of the print circuit board.

As shown in FIG. 5A to FIG. 5G, a countermeasure structure to prevent the electrode 35b from detaching from the recess 37a, for example, can preferably have various shapes. FIG. 5A illustrates a countermeasure structure defined by an inclined side surface 61a similar to that described in FIG. 2. FIG. 5B illustrates a countermeasure structure defined by a horned projection 61b at the upper portion of the electrode 35b. FIG. 5C illustrates a countermeasure structure defined by a circular projection 61c at the upper portion of the electrode 35b. FIG. 5D illustrates a countermeasure structure defined by a hook projection 61d at the upper portion of the electrode 35b. FIG. 5E illustrates a countermeasure structure defined by a jagged zig-zag edge 61e at the side surface of the electrode 35b. FIG. 5F illustrates a countermeasure structure defined by an inclined concavity 61f at the side surface of the electrode 35b. FIG. 5G illustrates a countermeasure structure defined by a concavity 61g at a central portion of the side surface of the electrode 35b.

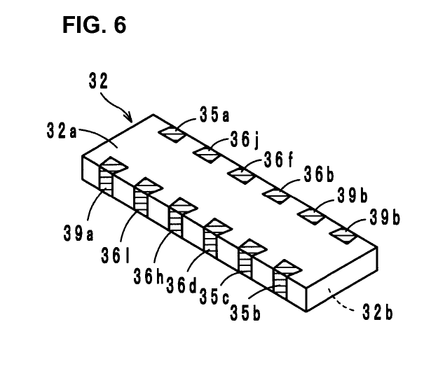

FIG. 6 shows a ferrite 32 which is a main portion of a non-reciprocal circuit device according to a second preferred embodiment of the present invention. This ferrite 32 includes a countermeasure structure to prevent detachment of the upper electrodes 35a, 36b, 36f, 36j and 39b in addition to the lower electrodes 35b, 35c, 36d, 36h, 36l and 39a. The shape of the countermeasure structure preferably is substantially the same as that of the first preferred embodiment of the present invention. (see FIG. 5A)

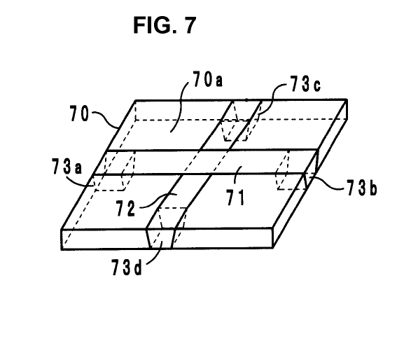

FIG. 7 shows a ferrite 70 which is a main portion of a non-reciprocal circuit device according to a third preferred embodiment of the present invention. On a first main surface 70a (front surface) of the ferrite 70, a first central electrode 71 and a second central electrode 72 are arranged so as to cross each other with a predetermined angle and so as to be electrically insulated from each other, and each end of the central electrodes 71 and 72 are connected to electrodes 73a to 73d, respectively. The electrode 73a which is connected to a first end of the first central electrode 71 is connected to a input port, and the electrode 73b which is connected to a second end of the first central electrode 71 and the electrode 73c which is connected to a first end of the second central electrode 72 are connected to a output port. The electrode 73d which is connected to a second end of the second central electrode 72 is connected to a ground port.

The ferrite 70 is disposed on a circuit board, which is not shown, such that the main surface 70a is horizontally aligned with the circuit board. The electrodes 73a to 73d are arranged to extend from the top surface to the bottom surface at the edge surface of the ferrite 70, and are electrically connected to terminal electrodes on the circuit board. A countermeasure structure defined by inclined side surfaces similar to those shown in FIG. 5A is provided for the electrodes 73a to 73d to prevent detachment.

The present invention is not limited to the above described preferred embodiments, and the non-reciprocal circuit devices of the present invention can be modified in various ways within the scope of the present invention.

For example, by inverting the N pole and the S pole of the permanent magnet, the input port P1 and the output port P2 are switched. The first and second central electrodes 35, 71, 36 and 72 may be bifurcated into multiple lines. The second central electrode 36 in the first preferred embodiment of the present invention may be wound one or more turns.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A non-reciprocal circuit device comprising:
a permanent magnet;
a ferrite arranged to receive a direct-current magnetic field from the permanent magnet;
a plurality of central electrodes defined by a conductive film and arranged on the ferrite so as to cross each other and so as to be electrically insulated from each other;
electrode conductors disposed in recesses provided on edge surfaces of the ferrite which are perpendicular or substantially perpendicular to main surfaces of the ferrite; wherein
the electrode conductors are electrically connected to the plurality of central electrodes and to terminal electrodes which are provided on a circuit board; and
the electrode conductors include a countermeasure structure arranged to prevent detachment of the electrode conductors from the recesses when a pulling force is applied to portions of the electrode conductors joined to the terminal electrodes.

2. The non-reciprocal circuit device according to claim 1, wherein the plurality of central electrodes include a first central electrode and a second central electrode, a first end of the first central electrodes is electrically connected to an input port and a second end of the first central electrode is electrically connected to an output port, a first end of the second central electrodes is electrically connected to an output port and a second end of the second central electrode is electrically connected to a ground port, a first matching capacitor is electrically connected between the input port and the output port, a second matching capacitor is electrically connected between the output port and the ground port, and a resistor is electrically connected between the input port and the output port.

3. The non-reciprocal circuit device according to claim 2, wherein the ferrite includes a pair of the permanent magnets arranged in parallel or substantially parallel with a first and second main surface of the ferrite on which the first central electrode and the second central electrode are respectively arranged.

4. The non-reciprocal circuit device according to claim 3, further comprising a circuit board including terminal electrodes provided thereon, wherein first and second main surfaces of the ferrite-magnet assembly are arranged on the circuit board perpendicularly or substantially perpendicularly to a main surface of the circuit board.

5. The non-reciprocal circuit device according to claim 1, wherein a first central electrode and a second central electrode are arranged on a first main surface of the ferrite so as to cross each other and so as to be electrically insulated from each other, and a second main surface of the ferrite is arranged to face the circuit board on which terminal electrodes are provided on a surface thereof.

6. The non-reciprocal circuit device according to claim 1, wherein the countermeasure structure is defined by an inclined side surface of the electrode conductors.

7. The non-reciprocal circuit device according to claim 1, wherein the countermeasure structure is defined by a horned projection at an upper portion of the electrode conductors.

8. The non-reciprocal circuit device according to claim 1, wherein the countermeasure structure is defined by a circular or substantially circular projection at an upper portion of the electrode conductors.

9. The non-reciprocal circuit device according to claim 1, wherein the countermeasure structure is defined by a hook projection at an upper portion of the electrode conductors.

10. The non-reciprocal circuit device according to claim 1, wherein the countermeasure structure is defined by a jagged zig-zag edge at a side surface of the electrode conductors.

11. The non-reciprocal circuit device according to claim 1, wherein the countermeasure structure is defined by an inclined concavity at a side surface of the electrode conductors.

12. The non-reciprocal circuit device according to claim 1, wherein the countermeasure structure is defined by a concavity at a central portion of a side surface of the electrode conductors.
